(19) United States
(12) Patent Application Publication
(10) Pub. No.: US 2013/0300557 A1
(43) Pub. Date: Nov. 14, 2013

(54) ALERT AND RESPONSE MESSAGING BETWEEN DEVICES

(71) Applicants: Joe J. Ackerson, Raleigh, NC (US); Jared T. Chelko, Durham, NC (US); Chaise A. Crosby, Raleigh, NC (US); Doel L. Gonzalez, Cary, NC (US)

(72) Inventors: Joe J. Ackerson, Raleigh, NC (US); Jared T. Chelko, Durham, NC (US); Chaise A. Crosby, Raleigh, NC (US); Doel L. Gonzalez, Cary, NC (US)

(73) Assignee: INTERNATIONAL BUSINESS MACHINES CORPORATION, Armonk, NY (US)

(21) Appl. No.: 13/467,597

(22) Filed: May 9, 2012

(51) Int. Cl. G08B 23/00

(52) U.S. Cl. 340/501

(57) ABSTRACT

A computer-implemented method for providing an alert message comprises receiving input from a user specifying a destination to which an alert message is to be sent in the event of an interruption of an execution of a process; monitoring the execution of the process to determine if the execution is interrupted; creating an interruption alert if the execution of the process is interrupted; and sending the interruption alert to the specified destination.

### BACKGROUND

The present invention relates to data processing, and more particularly to systems, methods, and computer program products for providing an alert message. When a user initiates a long process on device (e.g., install/uninstall, calculation, or defrag), the user does not wait for the process to complete and in some cases the user is required to leave the system idle as to not interfere with the process. The user may then leave the device unattended to complete its work without checking its progress (such as at the end of the day, overnight, etc.). If the procedure is interrupted for any reason (e.g., disk space full, other applications running, unable to locate file, system busy) the user is unaware and unable to respond/react to the alert. Thus, a process that could have finished now has to be restarted or continued when the user returns to the device, rather than the process being complete as the user was expecting.

### BRIEF SUMMARY

In one embodiment of the invention, a computer-implemented method for providing an alert message comprises receiving input from a user specifying a destination to which an alert message is to be sent in the event of an interruption of an execution of a process; monitoring the execution of the process to determine if the execution is interrupted; creating an interruption alert if the execution of the process is interrupted; and sending the interruption alert to the specified destination.

In addition to the method for providing an alert message, as described above, other aspects of the present invention are directed to corresponding systems and computer program products for providing an alert message.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flowchart of a method of providing an alert message, in accordance with an embodiment of the present invention;

FIG. 2 is a schematic block diagram of a computer network in which embodiments of the present invention may operate; and

FIG. 3 is a schematic block diagram of a computer in the network of FIG. 2.

### DETAILED DESCRIPTION

Embodiments of the invention may provide the ability to, when a process executing on a first device is interrupted, to alert a user at a second device. When so notified, the user may then take action to address and remedy the interruption using the second device (such as, for example, by selecting one or more options for responding that may be included in the alert message) or returning to the first device to take action to address and remedy the interruption.

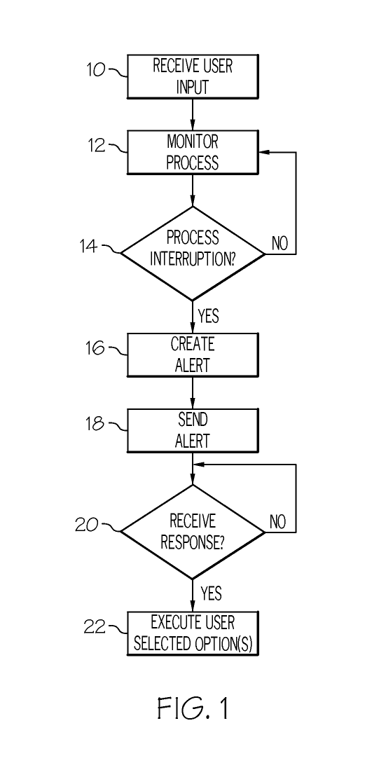

Referring now to FIG. 1, a flowchart of a method of providing an alert message is illustrated in accordance with an embodiment of the invention. When a user initiates a process that is expected to execute for a long time (e.g., installing or uninstalling a computer program, performing a complex calculation, or defragmenting a data storage device) on a device (such as a personal computer (PC) or other microprocessor-based device), the user may be prompted to input information that specifies a destination to which an alert message is to be sent in the event the execution of the process is interrupted.

Such an interruption may be expected or unexpected. An expected interruption may occur, for example, because the executing process requires user input to complete the process. For example, when installing a computer program, the user may need to specify a memory location to which the program is to be installed. An unexpected interruption may occur, for example, when the execution of the process fails. For example, the installation of a computer program may fail if there is insufficient memory available.

When the user-specified destination is received (block 10), the destination may be stored in memory. The user-specified destination may be, for example, a mobile device identity such as a mobile phone number for voice/SMS, an email address, a network/MAC address, a Bluetooth identifier, etc. The user-specified destination may be any identifier by which an alert message may be sent to the user such that the user can receive or access the alert message on a device separate from the device on which the process is executing.

The execution of the process is monitored (block 12) to detect if an interruption occurs. If it is determined at block 12 that the process has been interrupted, an interruption alert is created (block 16). The interruption alert could simply include a notification that the process has been interrupted. Additionally, the interruption alert could include the notification(s) that normally is/are displayed on the device on which the process is executing. Yet further, the interruption alert could include one or more user-selectable options for responding to the interruption. Such user-selectable options may for example, include “Skip this step”, “Retry”, “Ignore”, or “Abort”, as well as additional tasks could be executed (erase files, browse for files/images, kill other processes, etc.). The interruption alert may be configured to allow only one option to be selected or may allow multiple options to be selected, as appropriate.

The created interruption alert is sent to the user (block 18) using the destination information previously specified by the user. Thus, the interruption alert may be sent as an email, an SMS or text message, or in any other suitable format using any other suitable transmission means. When the user receives the interruption alert, the user may have several options for responding depending on the type of interruption alert (described above) and the type of interruption. If the interruption alert simply includes a notification that the process has been interrupted, the user may have to go to the device on which the process was executing to address the interruption. If the interruption alert includes one or more user-selectable options for responding to the interruption, the user may select one or more appropriate options for responding. The interruption alert may enable user selection of one or more of the options by, for example, including selectable hypertext associated with each of the user-selectable options. Alternatively, the interruption alert may include instructions for the user to select from one or more keyword/action commands (e.g., retry, cancel, ignore) by including the selected command(s) in the user's response. For example, the user may respond to the interruption alert and type the desired command word into the subject line or the body of the message (if replying via email). The user may also respond to the interruption alert by specifying a file path, which may or may not be a file path suggested in the interruption alert. Yet further alternatively, the interruption alert may include a plurality of buttons (or other similar selection devices), each associated with an option the user may select by touching or clicking the appropriate button. The interruption alert could include executable code that, when the user touches or clicks a button, causes the user's device to create and send a reply message with the selected option specified. Selecting one or more of the options causes (either automatically or with additional user input) a response to be sent from the user to the device on which the process was executing. It is determined at block 20 if such a response has been received from the user. If so, the user selected option(s) is/are executed to address the interruption (block 22).

Embodiments of the invention help enable the process to complete in a timely manner and prevent the user from having to return to a device to address an interruption.

Implementations of embodiments of the invention may be managed within a kernel or system OS (operating system) process which could monitor process IDs (identifiers) for process duration and intensity, thus allowing for monitoring of running processes and as such potentially preventing this functionality from having to be implemented at the application level. As such, embodiments of the invention may also allow for direct memory and processor access, simplifying the task so the embodiments of the invention may not require triggering services to manage such processes that could expose security risks and OS integrity.

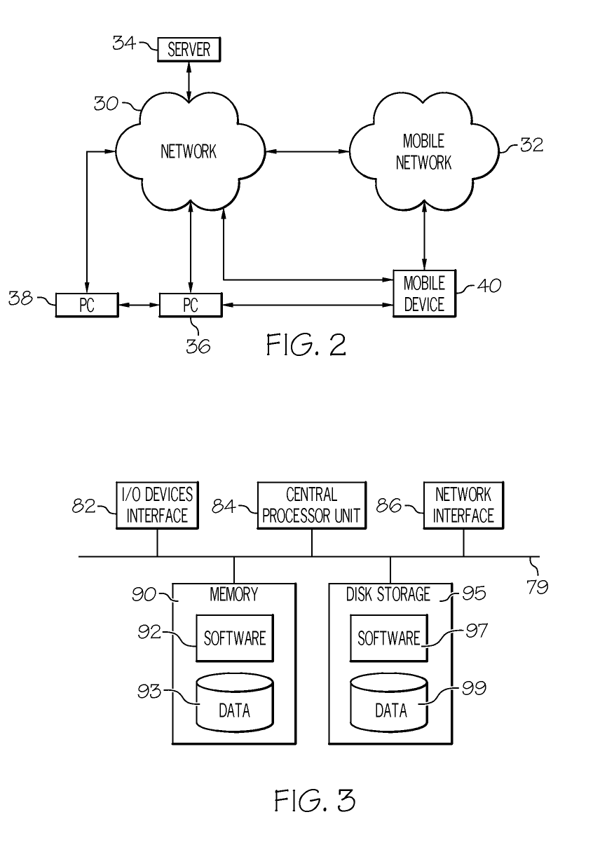

FIG. 2 is a schematic block diagram of a system in which embodiments of the present invention may operate. In the system of FIG. 2, computer 36 may be the device on which the process is executing. The system of FIG. 2 may enable interruption alert messages to be sent from computer 36 over communications network 30 to computer 38 (such messages may be sent via server 34). Alternatively, interruption alert messages may be sent directly from computer 36 to computer 38. As another option, interruption alert messages may be sent from computer 36 to mobile device 40, such as via communications network 30 to mobile network 32, and then from mobile network 32 to mobile device 40. Alternatively, interruption alert messages may be sent from computer 36 directly to mobile device 40. As another option, interruption alert messages may be sent from computer 36 to mobile device 40 via communications network 30 (for example, if mobile device 40 has Wi-Fi connectivity). Yet further alternatively, interruption alert messages may be sent from mobile device 40 to another mobile device (not illustrated) such as via communications network 30, via mobile network 32, or via communications network 30 and mobile network 32. As described above, the messages going to and from the devices illustrated in FIG. 2 may be sent using any suitable message type, such as email, SMS/text, etc.

Computers 36, 38, server 34, and mobile device 40 provide processing, storage, and input/output devices executing application programs and the like. Communications network 30 can be part of the Internet, a worldwide collection of computers, networks, and gateways that currently use the TCP/IP suite of protocols to communicate with one another. The Internet provides a backbone of high-speed data communication lines between major nodes or host computers, comprising thousands of commercial, government, educational, and other computer networks, that route data and messages. However, computers 36, 38 and server 34 may be linked over any suitable communication network. Mobile network 32 may be any suitable mobile communications/data architecture (such as a mobile telecommunications network adhering to the International Mobile Telecommunications-2000 (also termed 3G) or IMT-Advanced (also termed 4G) standards), in which a mobile telecommunications device (e.g., cell/mobile telephone such as mobile device 18) communicates.

FIG. 3 is a diagram of one possible internal structure of a computer (e.g., computer 36, 38) or server (e.g., server 34) in the system of FIG. 2. Each computer typically contains system bus 79, where a bus is a set of hardware lines used for data transfer among the components of a computer. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., displays, printers, speakers, microphones, etc.) to the computer. Alternatively, the I/O devices may be connected via one or more I/O processors attached to system bus 79. Network interface 86 allows the computer to connect to various other devices attached to a network (e.g., network 30 of FIG. 2). Memory 90 provides volatile storage for computer software instructions 92 and data 93 used to implement an embodiment of the present invention. Disk storage 95 provides non-volatile storage for computer software instructions 97 and data 99 used to implement an embodiment of the present invention. Central processor unit 84 is also attached to system bus 79 and provides for the execution of computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. If the service is also available to applications as a REST interface, then launching applications could use a scripting language like JavaScript to access the REST interface. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A computer-implemented method for providing an alert message, comprising:
receiving input from a user specifying a destination to which an alert message is to be sent in the event of an interruption of an execution of a process;
monitoring the execution of the process to determine if the execution is interrupted;
creating an interruption alert if the execution of the process is interrupted; and
sending the interruption alert to the specified destination.

2. The method of claim 1, wherein the interruption alert comprises a plurality of user-selectable options for responding to the interruption of the process.

3. The method of claim 2, further comprising:
receiving a response from the user with a selection of one of the user-selectable options; and
executing the selected user-selectable option.

4. The method of claim 1, wherein the execution of the process occurs on a first device and the destination to which an alert message is to be sent comprises a second device.

5. The method of claim 1, further comprising:
prompting a user to provide the destination to which an alert message is to be sent in the event of an interruption of an execution of a process.

6. A system for providing an alert message, the system comprising, a computer processor, a computer memory operatively coupled to the computer processor, the computer memory having disposed within it computer program instructions configured for:
receiving input from a user specifying a destination to which an alert message is to be sent in the event of an interruption of an execution of a process;
monitoring the execution of the process to determine if the execution is interrupted;
creating an interruption alert if the execution of the process is interrupted; and
sending the interruption alert to the specified destination.

7. The system of claim 6, wherein the interruption alert comprises a plurality of user-selectable options for responding to the interruption of the process.

8. The system of claim 7, wherein the computer memory having disposed within it computer program instructions further configured for:
receiving a response from the user with a selection of one of the user-selectable options; and
executing the selected user-selectable option.

9. The system of claim 6, wherein the execution of the process occurs on a first device and the destination to which an alert message is to be sent comprises a second device.

10. The system of claim 6, wherein the computer memory having disposed within it computer program instructions further configured for:
prompting a user to provide the destination to which an alert message is to be sent in the event of an interruption of an execution of a process.

11. A computer program product for providing an alert message, the computer program product comprising a computer readable storage medium having computer readable program code embodied therewith, the computer readable program code comprising:
computer readable program code configured for receiving input from a user specifying a destination to which an alert message is to be sent in the event of an interruption of an execution of a process;
computer readable program code configured for monitoring the execution of the process to determine if the execution is interrupted;
computer readable program code configured for creating an interruption alert if the execution of the process is interrupted; and
computer readable program code configured for sending the interruption alert to the specified destination.

12. The computer program product of claim 11, wherein the interruption alert comprises a plurality of user-selectable options for responding to the interruption of the process.

13. The computer program product of claim 12, further comprising:
computer readable program code configured for receiving a response from the user with a selection of one of the user-selectable options; and
computer readable program code configured for executing the selected user-selectable option.

14. The computer program product of claim 11, wherein the execution of the process occurs on a first device and the destination to which an alert message is to be sent comprises a second device.

15. The computer program product of claim 11, further comprising:
computer readable program code configured for prompting a user to provide the destination to which an alert message is to be sent in the event of an interruption of an execution of a process.
